(19) United States
(12) Patent Application Publication
(10) Pub. No.: US 2024/0177441 A1
(43) Pub. Date: May 30, 2024

(54) INFORMATIONAL INTERACTIVE ENVIRONMENT TRANSITION

(71) Applicant: Build a Rocket Boy Games Ltd., Edinburgh (GB)

(72) Inventor: Leslie Peter Benzies, Edinburgh (GB)

(21) Appl. No.: 18/413,944

(22) Filed: Jan. 16, 2024

Related U.S. Application Data
(63) Continuation-in-part of application No. 18/184,859, filed on Mar. 16, 2023, now Pat. No. 11,875,471.
(60) Provisional application No. 63/481,139, filed on Jan. 23, 2023.
(60) Provisional application No. 63/320,456, filed on Mar. 16, 2022.

(51) Int. Cl. G06T 19/20; G06T 13/40; G06T 19/00

(52) U.S. Cl. CPC G06T 19/20; G06T 13/40; G06T 19/003; G06T 2219/2004

(57) ABSTRACT

The present disclosure relates to a system for controlling an interactive virtual environment. The system includes a computer for generating a three-dimensional computer-generated environment including a player controllable character within the three-dimensional computer-generated environment, displaying a portal within a portion of the three-dimensional computer-generated environment the portal active to enable the player controllable character to transition to a new interactive experience, and displaying in proximity to the portal information related to the new interactive experience and visible to the player controllable character.

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### RELATED APPLICATION INFORMATION

This patent claims priority from U.S. provisional patent application No. 63/481,139 entitled “INFORMATIONAL INTERACTIVE ENVIRONMENT TRANSITION” filed Jan. 23, 2023, the entire content of which is incorporated herein by reference.

This patent claims priority as a continuation-in-part from U.S. patent application Ser. No. 18/184,859, now U.S. Pat. No. 11,875,471 entitled “THREE-DIMENSIONAL ENVIRONMENT LINEAR CONTENT VIEWING AND TRANSITION” filed Mar. 16, 2023 and issued on Jan. 16, 2024 which in turn claims priority to U.S. provisional patent application No. 63/320,456 entitled “INTERACTIVE ENVIRONMENT LINEAR CONTENT VIEWING AND TRANSITION” filed Mar. 16, 2022, the entire content of both are incorporated herein by reference.

### BACKGROUND

### Field

This disclosure relates to interactive three-dimensional computer-generated environments and, more particularly, to providing an informational preview of a new interactive environment into which a player controlled character may transition.

### Description of the Related Art

There exist various ways for users to interact with computer user interfaces or interactive environments. As each new advancement in user interface or user interaction with computing devices occurs, it typically takes a few years for the appropriate physical interface to be developed or to take hold for interacting with that interface. In what is now quite an old example, Xerox developed a PARC user interface for its copiers and other devices in the late 1970s. One of the metaphors employed by the system was the use of so-called “windows.” Initially, the interface was designed for touch-screen interaction, and a keyboard alone was found to be inadequate and clumsy for interaction with the user interface.

Within a short period after development of the windows metaphor, Xerox realized that the computer mouse, which could be used to move a cursor to a particular (x,y) location on a screen was the best way to interact with such a user interface. Virtually every operating system developed since has relied upon this same metaphor and user input device. More recently, Apple® acquired a company called FingerWorks in approximately 2005 for so-called “multi-touch” interactions. The underlying technology came to be used in virtually every iOS touchscreen to enable complex touch-based interactions on glass displays.

In a more recent vein, this development process is still ongoing in the ambit of virtual reality (VR) and augmented reality (AR) interactions. Virtual reality headsets have been around for years but have been complex and expensive. Now that they are hitting the mass marketplace, they are primarily being shipped with some form of controller. The best of those controllers rely upon infrared lighting to perform controller tracking to enable very detailed interactions in virtual space. Metaphors for “grasping” objects (e.g. a virtual ball in a virtual world) are developing using triggers and similar controller metaphors carried over from computer gaming. These metaphors and interactions are in the process of refinement and development.

However, even the strongest proponents of the use of hardware controllers look to a future where an individual user's VR hands will be tracked (by a headset or by an overall environment) and the user will interact with the virtual world in much the same way he or she interacts with the real world. Even with the best of infrared or visual hand-tracking systems, it seems inevitable that some metaphor that differs at least slightly from real-world interactions will be required for these virtual reality environments. Much like the introduction of the mouse in a “windows” environment, virtual reality and augmented reality software designers are actively working on the best and most natural ways to interact with a computing device in these new paradigms. The process of developing the human and machine interface for virtual and augmented reality is ongoing.

The metaphors for computer gaming on computers and video game consoles are well-developed. Users start software on a computer or gaming device to begin a particular experience. The controls for an on-screen avatar are relatively fixed. And, in a typical case, the gameplay mechanics and gameplay loop are relatively fixed. For example, in a first person shooter style game, a player avatar is usually controlled with a keyboard or an analog stick of a game controller, while an “aim” (typically the center of the screen) is controlled by the mouse or another analog stick. The mechanic is roughly: move the avatar around (in first or third person, depending on the game), aim the weapon at an enemy, fire the weapon and (hopefully) win a bout with other players or non-player characters controlled by the game.

A so-called “platformer” game mechanic involves moving a player avatar from platform to platform through a series of actions over a set arena or area to a “finish line” or other goal. Sometimes the metaphors are mixed, an first person shooter (FPS) with platforming elements, or a roleplaying game with FPS elements and the like. But, in general, the mechanic and gameplay loop remain constant for a given game.

Some more complex games enable two or more gameplay mechanics in the same game. For example, the certain types of games include driving portions where a player controls a car (e.g. a car being stolen or moving the player avatar about a city) and also includes an FPS-like element where the avatar moves about in the city “walking” around. There may be flying portions wherein the player controls a flying plane or helicopter. There may also be dialogue options in such games that may change the overarching story or cause the game world to change in some way.

There are still other games or experiences built upon these basic concepts that enable various types of gameplay from the same controls and within the same “game.” Roblox® is one such example. Roblox is a sandbox-style game that enables players to meet their “friends” online in one or more virtual worlds or environments. However, within Roblox, third parties may offer other experiences or games. These are typically quite simple games, but they alter the overall experience within Roblox. These other experiences remain within the overall construct, control scheme, and gameplay mechanics of the overall Roblox® experience.

The inventor envisions a different kind of gameplay experience wherein a user may engage in any number of distinct gameplay or experiences while within or a part of an overall interactive environment. The user may transition seamlessly between a “hang out” experience and a “game” experience. One metaphor discussed in the Prior Applications is the use of a VR headset within a given interactive experience as a “gateway” to another interactive experience. The metaphor employed is the player avatar donning the VR headset within the first interactive experience to move into another interactive experience. Likewise, the player avatar may remove one VR headset to move back into a prior interactive experience.

In addition, the Prior Applications discuss the viewing of in-game content on virtual “screens” within the interactive experience. So, a player avatar may stand or sit in a virtual living room or theater, watching a virtual television which is a live stream of that player's friend playing a game that is a sub-part of the overall interactive experience. One example game that is shown is a first person shooter game being viewed (similar to a video game stream) on a large virtual movie theater screen within a virtual movie theater.

Experiences within an interactive environment are many. And the metaphors used for transition from one experience to the next may vary depending on the context. Video game players in particular like to experiment and try different approaches to an interactive environment.

In a traditional game context, these transitions between experiences would be between different games or, when within games like Legend of Zelda: Breath of the Wild®, there would be clear, visual delineation such as a player avatar walking up to a horse, mounting the horse, and beginning to ride the horse. Similar interactions are available in other games with walking to driving a car. To a player the transition from a “walking” game to one on which the player is driving or riding a horse is clear. The player's avatar has entered the car and appears in the driver's seat of the car. Other games, like the Tomb Raider® series or the Uncharted® series of games include puzzle elements mixed with shooting elements. The transition between the two play types is usually signaled with musical cues, the presence or absence of enemy characters, and other visual cues (e.g. walls that may be climbed, character dialogue, etc.). Again, the transitions occur within the same scene or location and are generally obvious to a player.

In a metaverse interactive environment, e.g. one in which a series of not-necessarily-related experiences are tied together by a single interactive environment, transitions may be dangerous for a player, unexpected, confusing, or otherwise unknown. For example, a player may be in a “hang-out” type space within the world in one moment, and dropped into a fighting game in the next. Or, dropped into a first person shooter or racing game in the next. The player has agency to select which experiences to take part in, but may make those choices based upon limited information.

As new gameplay mechanics and systems develop, interactive metaphors and control schemes likewise develop, usually with a short lag behind.

### DESCRIPTION OF THE DRAWINGS

FIG. 1 is an overview of a system for three-dimensional environment linear content viewing and transition.

FIG. 2 is a block diagram of an exemplary computing device.

FIG. 3 is a functional block diagram of a system for three-dimensional environment linear content viewing and transition.

FIG. 4 is an example three-dimensional character near a linear content display.

FIG. 5 is an example three-dimensional character jumping into a linear content display.

FIG. 6 is an example three-dimensional character jumping into a linear content display.

FIG. 7 is an example three-dimensional character transitioned into a new three-dimensional environment previously shown on the linear content display.

FIG. 8 is a flowchart of a process for linear content transition to a new three-dimensional environment.

FIG. 9 is a flowchart of a process for linear content transition to a new three-dimensional environment from the perspective of a user.

FIG. 10 is an example of a three-dimensional character moving toward a portal displaying transition information.

FIG. 11 is an example of a three-dimensional character moving toward a portal displaying transition information.

FIG. 12 is an example of a three-dimensional character moving toward a portal displaying transition information.

FIG. 13 is a flowchart of a process for displaying transitional information for a new interactive experience in a portal.

FIG. 14 is a flowchart of a process for comparing previously-set settings with parameters for a new interactive experience as a part of a transition to a new interactive experience through a portal.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

There is increasing desire for a different kind of gameplay experience wherein a user may engage in any number of distinct gameplay or experiences while within or a part of an overall interactive environment. The user may transition seamlessly between a “hang out” experience and a “game” experience. Even the game experiences themselves may vary, all while within one three-dimensional environment or experience. One metaphor is the use of a virtual VR headset within a given interactive experience as a “gateway” to another interactive experience. The metaphor employed is the player avatar donning the VR headset within the first interactive experience to move into another interactive experience. Likewise, the player avatar may remove one VR headset to move back into a prior interactive experience.

In-game content may be viewed on virtual “screens” within the interactive experience. So, a player avatar may stand or sit in a virtual living room or theater, watching a virtual television which is a live stream of that player's friend playing a game that is a sub-part of the overall interactive experience. In one example, a first-person shooter game being viewed (similar to a video game stream) on a large virtual movie theater screen within a virtual movie theater.

However, the experiences within the interactive environment are many. And the metaphors used for transition from one experience to the next may vary depending on the context. So, in a first person shooter “match” style game, a user may load-in to a game by starting the application and logging into a service. But, a game like Apex Legends® “drops” players into the game world from an airdrop rather than merely having them appear in set or random locations within the game world. So-called “open world” games often have a player “home” or base location where the user returns to store collected materials and repair cars or sleep for the night as a save mechanic. Further, video game players in particular like to experiment and try different approaches to an interactive environment.

Here, one or more player avatars may engage in an interactive experience. That experience may be on a personal computer, a gaming console, through a streamed “game” experience (e.g. Xbox Cloud, Nvidia Now, etc.), a VR headset, or other systems for enabling interactive entertainment. That interactive experience may incorporate in some form a stream of linear content. As used herein, “linear content” is two-dimensional recorded, live, or streamed content that is intended to be viewed from a beginning point to an end point, customarily without any form of user interactivity with that linear content, apart from potentially starting and stopping or pausing playback. Linear content is typically of the form of a video of a motion picture, a television show or series, a so-called “short” or may be a trailer for other content, or a pre-rendered cutscene. Linear content is explicitly not a rendered three-dimensional world in which a character or player may move about freely and with which the player may interact.

However, Linear content may be displayed on a virtual display within a three-dimensional environment or other interactive experience. So, a user or series of users within that three-dimensional environment may view that linear content. One such metaphor may enable an individual or group to watch linear content in such a virtual living room or movie theater. Within the three-dimensional environment, the content may be projected onto a large screen or within a movie theater while the participants watch together. The screen or display may itself be a “pop-up”display placeable by a player avatar anywhere within the world or it may be fixed (e.g. a jumbotron at a stadium or during a concert or simply always present).

Linear content may have a purpose, a theme, be related to a franchise or series, involve a particular superhero or crime-fighting team or character, be set in a particular world (e.g. Star Wars® or a Transformers® movie or series), involve a particular skill set or activity (e.g. skiing or cooking or skydiving) or otherwise involve some activity or be related to some other content or world. The content may be a dynamic screen that displays live content created by or taking part from a “streamer” of such content or even player friends currently playing a different experience within the three-dimensional environment (e.g. engaged in an FPS game or a racing game). A user may watch that content alone or with friends within the same interactive environment.

As the user watches the linear content, the user may wish to “join” the environment, world, characters, activity or the like for that linear content. Or the linear content may itself be an advertisement or invitation to participate in such an activity. In such a case, a player may control his or her player avatar so as to cause that player avatar to jump into, step into, or otherwise move through the linear content on the virtual display (e.g. television screen, theater screen, portal, etc.) to thereby move into or begin interacting with an interactive environment.

As used herein “associated with” in the context of a three-dimensional environment associated with linear content means that the three-dimensional environment “associated with” the linear content is somehow related to that linear content. In particular, the new three-dimensional environment or one “associated with” linear content is one which involves the same theme, world, characters, actions, activities, or elements from the linear content shown on the display. The three-dimensional environment “associated with” linear content is explicitly not generic content or merely another part of an existing game world or environment, it is a new environment with specific reference to or components from the linear content, but rendered as a part of the three-dimensional environment.

In so doing, the player may thereby indicate his or her desire to enter a new experience involving the theme, world, characters, activity, etc. for the linear content. The linear content can play the part of the transition space from a first three-dimensional environment to a second three-dimensional environment, the second having some relationship or association with the theme, setting, characters, or the like for the linear content being viewed on the display. The computer system may automatically and seamlessly transfer the player avatar (or generate a different, but related player avatar—e.g. a car for a racing game or Fast & Furious® linear content) to the different interactive experience associated with the linear content.

So, for example, a user may watch a cooking show (linear content) in a virtual kitchen within an interactive experience in which the player avatar is situated. Partway through the process of watching a chef prepare chicken piccata, a player may move his or her avatar into the display upon which the linear content showing the chicken piccata preparation is being shown. The system may cause the player avatar to transition to a different three-dimensional environment involving a kitchen and cooking game wherein a player may cook a virtual chicken piccata or simply take part in a simplified (or complex) cooking game or experience. Alternatively, a user may be transmitted to a virtual store where real-world ingredients to prepare chicken piccata may be purchased for pick up or delivery to that user's home.

The content may be branded or associated with a particular set of linear content. So, for example, a user may be watching one of the John Wick series of movies starring Keanu Reeves. A user may particularly like a given scene or a scene within the linear content may indicate that an interactive experience is available for the scene. So, for example, a scene within the movie involving a dramatic set of action sequences may indicate that an interactive experience is available. The user may wish to “participate” in this scene by jumping into the associated interactive experience. By “jumping” into the display showing the linear content as that scene plays, the user may indicate that intent and be transitioned to the playable experience.

The system described herein improves the functioning of the computer by streamlining the interaction of users within a three-dimensional environment to better-mimic how a user would choose to interact in the real world. In essence, the present system improves the functioning of the server system for interactive environments like those described herein by easing transition between content types and experiences. In the past, a user may launch a particular game software. To transition to a new game software or experience, the user must quit that game software and launch another game software. The present system streamlines that process by enabling seamless transition between content of disparate types through the use of a “teleport” like metaphor.

The present system also improves the interactivity of linear content. For many years, linear content such as film and television shows have desired to have more engagement with their fans. Many films and television shows have associated video games, but they generally only have the same characters and rough similarities of the storylines or themes. The present system can enable linear content creators to have direct interaction with their fans and customers through interactive experiences directly tied to their linear content. Creative linear content creators can even use the present systems to tailor linear content to user's desires or according to user interactions with an associated three-dimensional environment while viewing that linear content.

One metaphor for transitions between content types is a “portal.” To a player standing at a portal to another location within a metaverse-like world, a portal does not itself indicate much about the world beyond the portal. The portal may transition to a building-type area where a player may create or make worlds with construction materials, or may transition to a player-versus-player area where materials or objects held in the player's inventory may be lost should the player lose a battle. Traditionally, video game designers use visual cues for such transitions, making doorways that transport players dangerous locations covered in lava, red, volcanic or otherwise violent-looking. But, these transitions are never so jarring as they are when they move directly, without any transition from one location to another location as is possible and indeed common in a metaverse-like environment.

This shortcoming of the present art suggests that there should be some better system for protecting users from jarring transitions and for providing better information to players regarding the world beyond a transition such as a portal, door, or other metaphor that represents a transition to a wholly-different area of a game world, interactive environment or metaverse-like world.

One elegant way to handle this transition is to provide information about the world beyond on the portal itself. The portals may take many forms, for example, as doors, as actual swirling portals, as archways, as windows, as playing linear content (e.g. a television show or movie) floating or otherwise fixed in the interactive environment, as a VR headset that may be donned by a player avatar, as a “rabbit hole” like in Alice in Wonderland, or many other forms. But, these forms will all have textures applied to them and in general will have a plane through which a player avatar must past to signal that the player wishes to transition from the present environment to the next. The VR headset form is one that may not, but a projected plane or texture of information may appear above the VR headset when placed in focus by a player avatar or the player avatar may don the headset, get a preview of information before electing to move forward into the next world.

A proposed solution is to provide information—more or less detailed in a given context—on the portal itself or surrounding the portal that indicates key information about the interactive environment beyond. So, the portal may include information such as: the zone type (hang-out, FPS, driving, shooting, PVP, etc.), the zone danger level (e.g. no risk of attack, free for attack, risk of loss of items or money, no such risk, levels of non-player character monsters relative to the player avatar, etc.), an area age requirement such as areas which are unavailable to players under at 10 or under age 17 or the like, whether others will be or are present in the other zone or area, whether the zone has any special characteristics (e.g. its underwater, it's extremely hot, it's extremely cold, etc.), and other zone characteristics as relevant.

A shorthand for these characteristics may be made visually to enable quick evaluation by a player avatar rather than reading a careful description that requires time to consider. A description may be available in some cases if selected or desired by a user or may pop-up automatically for a player avatar or after the passage of a limited time looking at the information. This can aid in educating a player as to the meaning of the given shorthand symbols or visual characteristics.

So, for example, the shorthand may include a large “fire” icon for hot areas which may require special heat tolerant clothing or a “snowflake” icon for areas that are extremely cold and require suitable player avatar cold weather clothing. A “PVP” icon may appear to indicate that the zone beyond the portal is a player-versus-player area. A “skull” icon may indicate that it is too high level for your player avatar or may be too difficult. A number (e.g. representing a player avatar level or particular item level or the like) may appear on the portal to indicate a particular level is required or recommended if “levels” are used in a given game or in parts of a given metaverse experience.

Relatedly, the portal may incorporate or effectively be a display showing a preview of the area to which the portal goes. The display may show the type of experience (e.g. a racing game) and may offer an example video or image of past gameplay or live, streamed gameplay or video or other images of the goings-on within the world or area or zone beyond the portal. This may be overlaid or underlaid on top or behind the icons or written description and may offer a real-time glimpse as to the content of the expected experience beyond the portal.

The portal information may also include information related to whether you have any “friends” or social contacts who are within the given area or who have recently played within the zone or area through the portal. In this way, players may be encouraged to engage in activities that correspond with those of their friends or acquaintances and may be provided information to make those kinds of choices.

The portal may be dynamic and active in its response to players. The portal may operate to only be open to players with certain settings set or attributes. So, for example, if a player has set a setting indicating that they wish to avoid player-vs-player combat, the portal may simultaneously warn players that the experience beyond a given portal is a player-vs-player area and may not operate to enable a player to move from the present area to a player-vs-player area beyond the portal. The display may indicate that a user can move to that area if they disable the player-vs-player setting. Similarly, if a given area has a level recommendation or requirement, the portal may not function or may prompt a warning as a player tries to pass through that portal without meeting the recommendation or requirement. Similarly, a player may have indicated that he or she wishes to only enter children-friendly areas (or may only want their child entering such areas) of the game in a setting. A portal may fail to activate for areas beyond that setting, so that areas involving profanity, nudity, or strong violent images may not be accessible to children without altering the setting. And, the portal may indicate the inaccessibility of such areas are due to a setting, either with words or with a logo or icon on or near the portal.

### DESCRIPTION OF APPARATUS

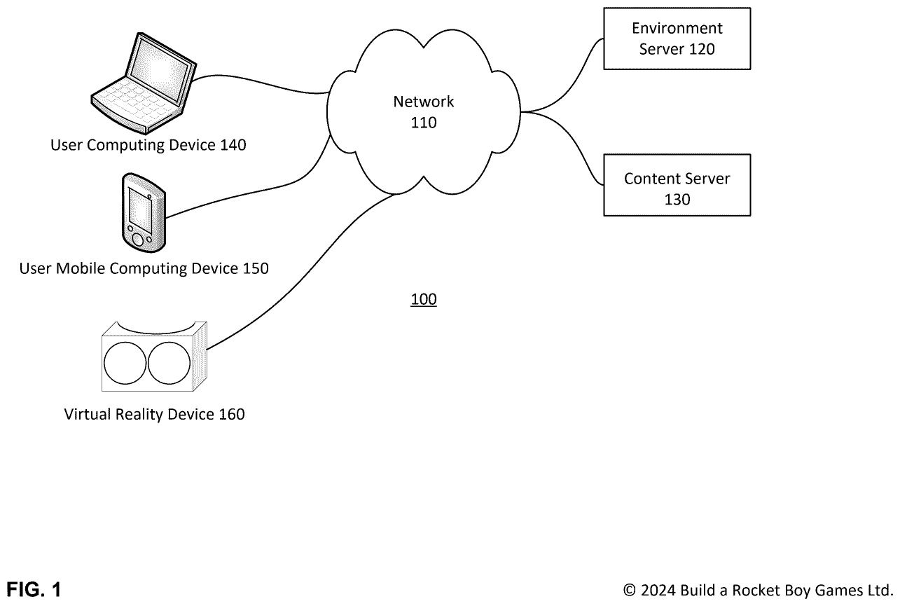

Referring now to FIG. 1, an overview of a system 100 for three-dimensional environment linear content viewing and transition is shown. The system 100 includes an environment server 120, a content server 130, a user computing device 140, a user mobile computing device 150, and a virtual reality device 160; all interconnected by a network 110.

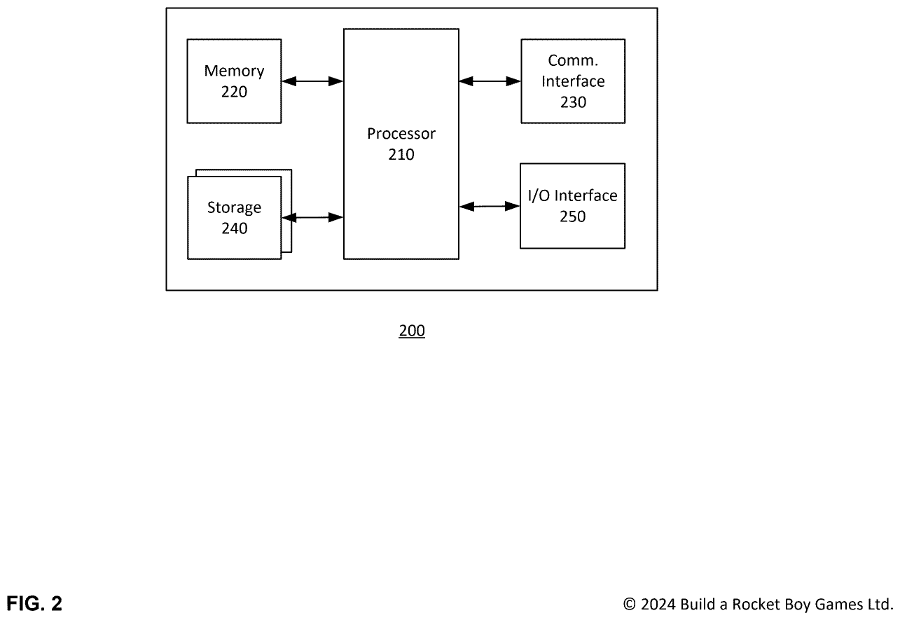

The environment server 120 is a computing device (FIG. 2) or a group of computing devices. The environment server 120 is used to store three-dimensional models and any textures associated with the various three-dimensional models. These models may be player characters, environments in which the models move about, virtual automobiles, clothing, furniture, buildings, means of transport, displays, plants, and components of each of the foregoing.

The environment server 120 may act much like a traditional “game server” to provide a server into which one or more players may log in order to move about in a virtual world comprised of the associated art assets, models and textures. The environment server may primarily operate as an orchestrator of multiple players as they connect and interact with one another, and to ensure integrity of the process of login, and uniformity of the three-dimensional environment (which may actually be rendered locally on each user's machine from a set of game assets and files).

The environment server 120 may be self-hosted, meaning operated by a company or entity that enables the functions and systems described herein. Alternatively, the environment server 120 may be on a shared resource service such as Amazon AWS or Microsoft Azure. Some or all of the environment server 120 may be hosted by the users of the system itself (e.g. a “chat” room made by players) so that users join their computer. In such cases, the environment server 120 or a portion thereof may actually be peer-to-peer hosted by one of the participants and merely orchestrated or controlled by a player.

The content server 130 is a computing device or a group of computing devices. The content server 130 stores and streams linear content for display on a fixed or movable display within the three-dimensional environment created by the environment server 120. So, the content server 130 may be a streaming service like Netflix® or Hulu®. However, in some cases the content server 130 may be or be a part of the environment server 120. This may be the case, for example, when the environment server 120 is used to display a linear content version of an ongoing game (e.g. a stream of an first person shooter (FPS) game or massively online battle arena (MOBA) game being played elsewhere within the environment). Or, in other cases, the content server 130 may be one or more of the user's computing devices. So, a user may host a “movie night” by streaming a film or television show from their local library or together with a friend from an online streaming service. In such a case, the content server 130 may be locally hosted by a user.

The user computing device 140 is a computing device such as a personal computer, laptop computer, desktop computer or the like. The user computing device 140 may be a typical consumer computing device, lacking in any significant specialized capabilities. However, the user computing device 140 may include a GPU or an integrated GPU (e.g. integrated into a single chip with a CPU). The user computing device 140 is used by a user to connect to the environment server 120 to move an avatar about within a three-dimensional environment generated by the environment server 120 (or, more accurately, on the user computing device 140 as directed by the environment server 120). The three-dimensional environment to which the user connects may enable that user to carry about a “pop-up” display for linear content that may be placed anywhere or virtually anywhere within the three-dimensional environment. The three-dimensional environment itself may incorporate one or more display screens for display of linear content thereon built-in to the environment (e.g. large billboards, virtual “television” monitors, and the like).

The user mobile computing device 150 is effectively identical to the user computing device, though its form factor may be that of a mobile device. It may, for example, be a mobile phone, a smart phone, a tablet computer, or other, similar device. It is shown to indicate that in some cases a user mobile computing device 150 may be used in place of the user computing device 140. Likewise, the virtual reality device 160 is another computing device that operates in much the same way as the user computing device.

FIG. 2 is a block diagram of an exemplary computing device 200, which may be or be a part of the environment server 120, the content server 130, the user computing device 140, the mobile computing device 150 or the virtual reality device 160 of FIG. 1. As shown in FIG. 2, the computing device 200 includes a processor 210, memory 220, a communications interface 230, along with storage 240, and an input/output interface 250. Some of these elements may or may not be present, depending on the implementation. Further, although these elements are shown independently of one another, each may, in some cases, be integrated into another.

The processor 210 may be or include one or more microprocessors, microcontrollers, digital signal processors, application specific integrated circuits (ASICs), or a systems-on-a-chip (SOCs). The memory 220 may include a combination of volatile and/or non-volatile memory including read-only memory (ROM), static, dynamic, and/or magnetoresistive random access memory (SRAM, DRM, MRAM, respectively), and nonvolatile writable memory such as flash memory.

The memory 220 may store software programs and routines for execution by the processor. These stored software programs may include an operating system software. The operating system may include functions to support the input/output interface 250, such as protocol stacks, coding/decoding, compression/decompression, and encryption/decryption. The stored software programs may include an application or “app” to cause the computing device to perform portions of the processes and functions described herein. The word “memory”, as used herein, explicitly excludes propagating waveforms and transitory signals. The application can perform the functions described herein.

The communications interface 230 may include one or more wired interfaces (e.g. a universal serial bus (USB), high definition multimedia interface (HDMI)), one or more connectors for storage devices such as hard disk drives, flash drives, or proprietary storage solutions. The communications interface 230 may also include a cellular telephone network interface, a wireless local area network (LAN) interface, and/or a wireless personal area network (PAN) interface. A cellular telephone network interface may use one or more cellular data protocols. A wireless LAN interface may use the WiFi® wireless communication protocol or another wireless local area network protocol. A wireless PAN interface may use a limited-range wireless communication protocol such as Bluetooth®, Wi-Fi®, ZigBee®, or some other public or proprietary wireless personal area network protocol. The cellular telephone network interface and/or the wireless LAN interface may be used to communicate with devices external to the computing device 200.

The communications interface 230 may include radio-frequency circuits, analog circuits, digital circuits, one or more antennas, and other hardware, firmware, and software necessary for communicating with external devices. The communications interface 230 may include one or more specialized processors to perform functions such as coding/decoding, compression/decompression, and encryption/decryption as necessary for communicating with external devices using selected communications protocols. The communications interface 230 may rely on the processor 210 to perform some or all of these function in whole or in part.

Storage 240 may be or include non-volatile memory such as hard disk drives, flash memory devices designed for long-term storage, writable media, and proprietary storage media, such as media designed for long-term storage of data. The word “storage”, as used herein, explicitly excludes propagating waveforms and transitory signals.

The input/output interface 250, may include a display and one or more input devices such as a touch screen, keypad, keyboard, stylus or other input devices. The processes and apparatus may be implemented with any computing device. A computing device as used herein refers to any device with a processor, memory and a storage device that may execute instructions including, but not limited to, personal computers, server computers, computing tablets, set top boxes, video game systems, personal video recorders, telephones, personal digital assistants (PDAs), portable computers, and laptop computers. These computing devices may run an operating system, including, for example, variations of the Linux, Microsoft Windows, Symbian, and Apple Mac operating systems.

The techniques may be implemented with machine readable storage media in a storage device included with or otherwise coupled or attached to a computing device 200. That is, the software may be stored in electronic, machine readable media. These storage media include, for example, magnetic media such as hard disks, optical media such as compact disks (CD-ROM and CD-RW) and digital versatile disks (DVD and DVD+RW), flash memory cards, and other storage media. As used herein, a storage device is a device that allows for reading and/or writing to a storage medium. Storage devices include hard disk drives, DVD drives, flash memory devices, and others.

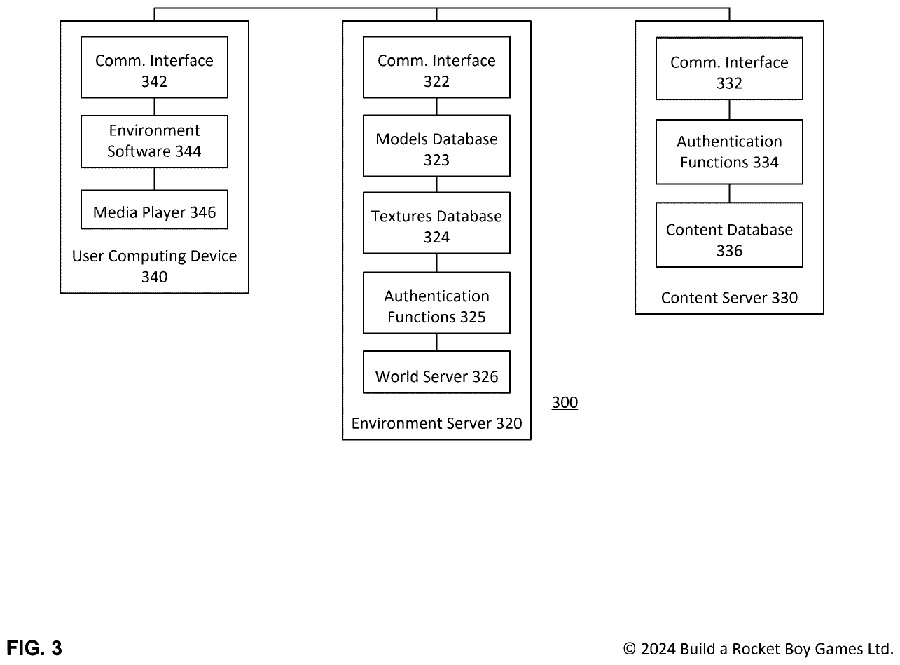

FIG. 3 is a functional block diagram of a system 300 for three-dimensional environment linear content viewing and transition. The system 300 includes the environment server 320, the content server 330, and the user computing device 340. The environment server 320 may be a version of environment server 120, the content server 330 may be version of server 130, and the user computing device 340 may be a version of device 140, 150 or 160. The mobile computing device and virtual reality device are not shown because their functions are substantially the same as the user computing device 340. These are functional elements, expressed in terms of their functionally. The functional elements shown in this figure may be physically divided or organized differently than shown from a functional perspective while still conforming to the overall intended functionality and purposes. The functions shown in this figure may be implemented in hardware or software or a combination of the two.

The environment server 320 includes a communications interface 322, a models database 323, a textures database 324, authentication functions 325, and a world server 326.

The communications interface 322 operates to enable communications between the interacting elements of the system like the content server 330 and the user computing device 340. The communications interface 322 may include the various hardware network components discussed above as a part of the computing device 200. However, it also may include application programming interfaces (APIs), unique network connectivity systems and data protocols used by the user computing device 340 and/or content server 330 to communicate with the environment server 320 securely and efficiently under the unique circumstances of the system 300.

The models database 323 stores the three-dimensional models used to generate the three-dimensional environment. These models may be the maps of the world, the locations, the objects making up the world (e.g. cars, boats, trees, tables, chairs, clothing, etc.). The models database 323 also stores the models for the player avatars used within the world by all of the players. These avatars may be uniquely-designed individually by each player or may have elements drawn from groups of “components” making up the avatar bodies (e.g. sets of eyes, sets of arms, sets of legs, etc.).

The textures database 324 stores the textures used in conjunction with the three-dimensional models stored in the models database 323 and used the generate the three-dimensional environment. The textures are applied by a three-dimensional engine to generate models with associated “skins” on those models. The textures appear as skin, clothing, tile on floors. Moving textures can even appear as television-like elements within the world or as animations on cars, avatars, and other elements of the generated three-dimensional environment.

The authentication functions 325 ensure that users (e.g. using user computing device 340) logging into the environment server 320 are properly authenticated. This may be as simple as a typical login function with a password, but may also employ two-factor authentication, fingerprint authentication, or other, secure methods. This is in part because the accounts associated with a given user or player in a given environment may have some value, may be sold or traded to others or may simply represent a great deal of time, effort, and investment on the part of the player. The type of ever-present world available in some forms of three-dimensional environments, such as so-called metaverse environments, can engender significant attachment to or identification with a player avatar. So, players may wish to have as secure a login process as possible to make sure that their avatars, and any digital belongings associated with that avatar, are secure.

The world server 326 orchestrates the other components of the environment server 320 to enable users connected to the environment server 320 to operate to generate the three-dimensional environment for users connected to the environment server 310. The world server 326 may operate in much the same way as a game engine or network game server operates. Though shown as a single server, it may be many physical servers. The world server 326 enables multiple users to connect to the environment server 320 to experience the same game world or three-dimensional environment simultaneously. To accomplish this, the world server 326 ensures authentication has taken place, loads the models and textures from the model database 323 and the texture database 324, and maintains an updating state for the overall game including player locations and movements and animations within the three-dimensional environment.

The world server 326 may simultaneously operate multiple world “types” so that users can transition from, for example, racing game to fighting game to “hang out” area to special linear content experience (discussed below), and so on. In this way, a single or multiple servers may be employed. In cases with a larger server population or particular game types that are overpopulated, sharded servers may be employed to load balance the total user population in a given area or on a server. The world server 326 may dynamically allocate and deallocate physical server capacity dependent upon the current load or need either in aggregate or for particular experiences.

In cases where linear content is streamed or otherwise shown within a three-dimensional environment, the world server 326 may operate to apply linear content from the content server 330 to a portion of the three-dimensional environment (e.g. a display or screen within the virtual world) so that the content may be viewed or viewable “in” the three-dimensional environment.

The content server 330 includes a communications interface 332, authentication functions 334, and a content database 336. Though shown as a single content server 330, there may in fact be many content servers, each hosted separately from one another. In other case, the user computing device 340 itself may be a content server 330 as well as operating to access linear content.

The communications interface 332 is primarily used to communicate requests for particular linear content from the user computing device 340 or the environment server 320 and to transmit the linear content requested to the environment server 320 and/or user computing device 340. The communications interface 332 may include the various hardware network components discussed above as a part of the computing device 200. However, it also may include application programming interfaces (APIs), unique network connectivity systems and data protocols used by the user computing device 340 and/or environment server 320 to communicate with the content server 330 securely and efficiently under the unique circumstances of the system 300.

The authentication functions 334 operate much the same as the authentication functions 325 of the environment server 320. However, these authentication functions 334 may be distinct from those of the environment server 320 in that they may involve authentication with a third party service (e.g. Netflix®) where streamed linear content or otherwise stored linear content is available for access. So, a user may be required to separately authenticate with a particular content server 330 in order to access the content database 336 and provide that data or that streamed content to the environment server 320 and the user computing device 340 for viewing. Accordingly, the authentication functions 334 may be implemented by a third party or rely upon the exchange of keys between the content server 330 and the environment server 320 and the user computing device 340 to enable the system 300 to operate to access linear content stored on the content server 330.

The content database 336 is a database storing the linear content for viewing by the user computing device 340 and/or the environment server. The linear content is preferably of a type that is suitable for streaming, reliant upon built-in redundancies in the encoding such that it may be readily streamed or transmitted over a network. Various forms of video content, particularly designed for compact, efficient encoding and streaming are known to those of skill in the art. Examples of suitable encoding schemes include H.264 and H.265.

The user computing device 340 is a computing device used by a user to access the environment server 320 and the content server 330. The user computing device 340 is shown as only a single device for example purposes, but a single environment server 320 and content server 330 can service numerous (hundreds or thousands) of simultaneous connections and interactions with user computing devices like user computing device 340. The user computing device 340 is commonly a desktop or laptop computer, but may be a mobile device or a virtual reality device or similar computing device. The user computing device 340 includes a communications interface 342, environment software 344 and a media player 346.

The communications interface 342 is primarily used to enable interaction of a player's avatar and software with the environment server 320 and to obtain and stream content from the content server 330. The communications interface 342 may include the various hardware network components discussed above as a part of the computing device 200. However, it also may include application programming interfaces (APIs), unique network connectivity systems and data protocols used by the user computing device 340 to communicate with the content server 330 or with the environment server 320 securely and efficiently under the unique circumstances of the system 300.

The environment software 344 is software for presenting the three-dimensional environment served by the environment server 320 to the user computing device 340. Traditionally, the environment software 344 would be an implementation of a “game engine” software that integrates three-dimensional models, textures for those models, scripting to enable functions and interaction within the three-dimensional environment, and various other functionality taking place within the environment server 320. The environment server 344 preferably integrates the authentication functions used by authentication functions 325 and 334 to enable the environment server 344 to access the world server 326 and content database 336 to enable the functions discussed herein. In a simplified sense, user may move a three-dimensional avatar about in a three-dimensional environment, interact with the environment, and may stream or otherwise access linear content served by the content server 330 from within the three-dimensional environment. Thereafter, the user may transition the player avatar to a new three-dimensional environment based upon interaction with the linear content displayed within the three-dimensional environment.

The media player 346 is software designed to play linear content. This software may be specialized in the sense that it operates within the three-dimensional environment shown on the user computing device 340 so that a user may view the linear content played by the media player 346 from within the three-dimensional environment, for example, on a virtual television display, a billboard or otherwise on a “screen” within the three-dimensional environment for viewing by those users (each connected via one of the user computing devices 340) within the three-dimensional environment.

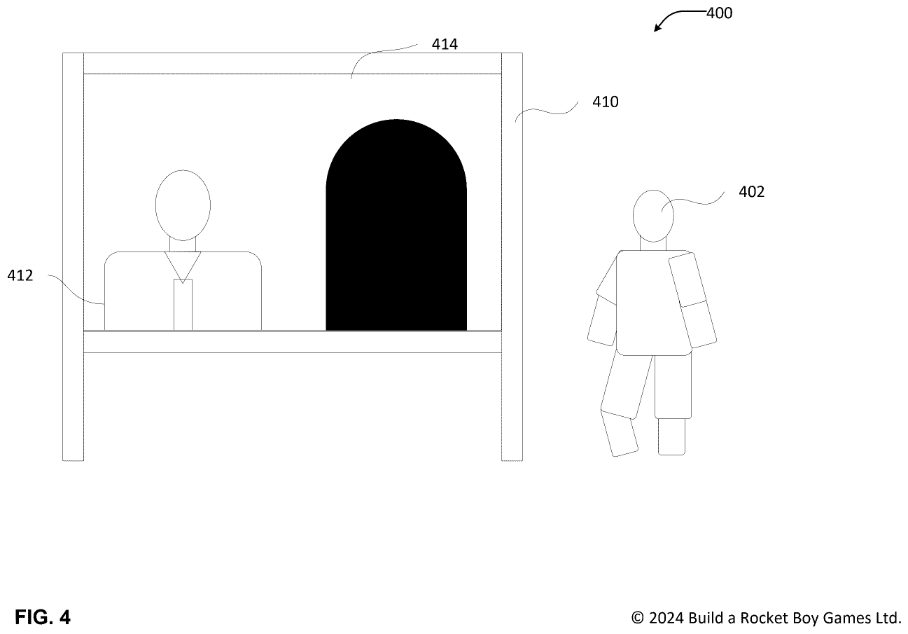

FIG. 4 is an example three-dimensional character in close proximity to a linear content display. As used herein “close proximity” means within a radius equivalent to 2-5 meters of a display showing linear content. Close proximity explicitly includes walking into, through or jumping into or through the display 414. The three-dimensional environment 400 includes the three-dimensional character 402 which may be an avatar of the player character. A display 410 is present within the three-dimensional environment 400. The display 410 is showing linear content 414 that is a scene (e.g. a scene from a film) including an actor playing a character 412 on the display 410.

The display 410 may be a fixed display within the location in the three-dimensional environment 400. Or, the display 410 may be a movable display, associated with the three-dimensional character 402 which the player may “set up” anywhere within the three-dimensional environment 400 for viewing of linear content. The display is a “virtual” display in the sense that it is not an actual computer display within the real world, it is a display showing linear content within a three-dimensional environment.

The display 410 may show or display linear content 414 as desired by or directed by the user associated with the three-dimensional character 402 within the three-dimensional environment 400. Alternatively, the display 410 may play linear content 414 selected by another player, by the three-dimensional environment themselves, by an advertiser or from a particular service or good (e.g. a streaming service may show content or advertisements for content like trailers for films) within the three-dimensional environment.

An indicator within environment 400 and associated with the linear content 414? May inform the player that the linear content shown on the display 410 is able to be joined by engaging with the linear content 414. This indicator may be a green light, may be a text or other indicator that appears when a user “mouses over” (e.g., using a mouse, keyboard or VR headset positioning or interaction) the display as alternative text, or may be more or less direct an indication. For example, the indication may be words appearing on screen that indicate a given scene of linear content may be “joined” or saying that “there is an interactive scene associated with this scene” which may appear on the screen. A particular icon or indicator image may appear on the display, environment 400 or on the user's computing device indicating that the scene is one which includes an associated three-dimensional environment. In other cases, the interactive element available to the user as a three-dimensional environment associated with the linear content may be a so-called “easter egg” that is only discoverable by accident or through experimentation with the display as the entire linear content plays. And, more basically, if a display is showing no content at all, there can be no associated three-dimensional environment associated with no content.

Only certain portions of time or area (e.g. a door or window) within the linear content may be associated with related interactive or immersive three-dimensional experiences. So, only certain scenes in movies may have one or more three-dimensional environments associated therewith. In other cases, an entire linear content (e.g. an entire episode of a television show) may be associated with a single three-dimensional environment recreating that scene or augmenting that scene or enabling the player character to interact with the scene within a three-dimensional environment. In some cases, or for certain time periods, the linear content may be associated with a particular three-dimensional experience.

So, by way of example, a linear content Simpsons episode associated with Homer's experiences in the nuclear power plant may include a portion of the linear content that is a single experience wherein a player can take on the role of Homer as he goes about his job working in the Springfield nuclear power plant, engaging in a mini-game. Alternatively, the Simpsons episode or every episode may be associated with a full-length commercial video game such that interacting with the display 410 causes the player character to enter a demonstration version of the new Simpsons video game to be played through the entire demo. In this way, the player may be encouraged to purchase or otherwise obtain the associated Simpsons game.

Further examples of portions of the linear content could include the display of a trailer for an upcoming film that plays on a display shown in a prominent location within the three-dimensional environment. The trailer may be for an upcoming action film. Player character engagement with the display 410 may cause the player three-dimensional character 402 to transition to a new three-dimensional environment which is a recognizable portion of the world or experience from the associated universe of the film. So, for a Marvel trailer, the experience may involve interactions with Spiderman or a mini-game swinging from spider webs in New York. Or, for a film involving dramatic action sequences of racing or shootouts, the player avatar may be placed into the world of the film and take the wheel of a fast car within a racing game or may be involved in a shootout within a game world that mirrors the scenes shown in the trailer.

In this way, the player may be drawn more into the “world” or environment of the linear content to experience some aspect of that world or environment. From a user perspective, this enables the player to have a deeper connection to and interaction with the world than merely watching the linear content. From the intellectual property owner of the linear content perspective, the user engagement with their television series, film, or other linear content increases interest in the content and buy-in from one or more desired consumers of that content.

Similarly, the linear content may be a replay of a video game competition that took place earlier or that is taking place live. It may also be a stream of a video game currently being played by a friend of the player. In such a case, the user may watch the stream and be encouraged to engage in the video game. Interaction with the display 410 may cause the player three-dimensional character 402 to join the live game with their friend or, in the case of an ongoing video game competition, to merely join or gain access to a lobby or demonstration version of the game or, if the game is already owned, to begin playing the game shown on the display 410. In this way, players may be reminded by the linear content that they enjoy a particular game or may enjoy it and may be invited to join it easily and quickly with limited or no interaction outside of the three-dimensional environment.

As used herein the phrase “new three-dimensional environment” or “non-linear three-dimensional environment” or “three-dimensional experience” mean three-dimensional environments, other than a general or baseline game world or three-dimensional environment, and instead are those that are expressly associated with a specific linear content or portion of a linear content. The experiences that a player three-dimensional character 402 joins may be mini-games, full video games, or may be purpose-built versions or iterations of scenes within the linear content designed to allow a player to “experience” the world of the linear content. Once the player has completed the three-dimensional experience, the player may return to the original three-dimensional environment.

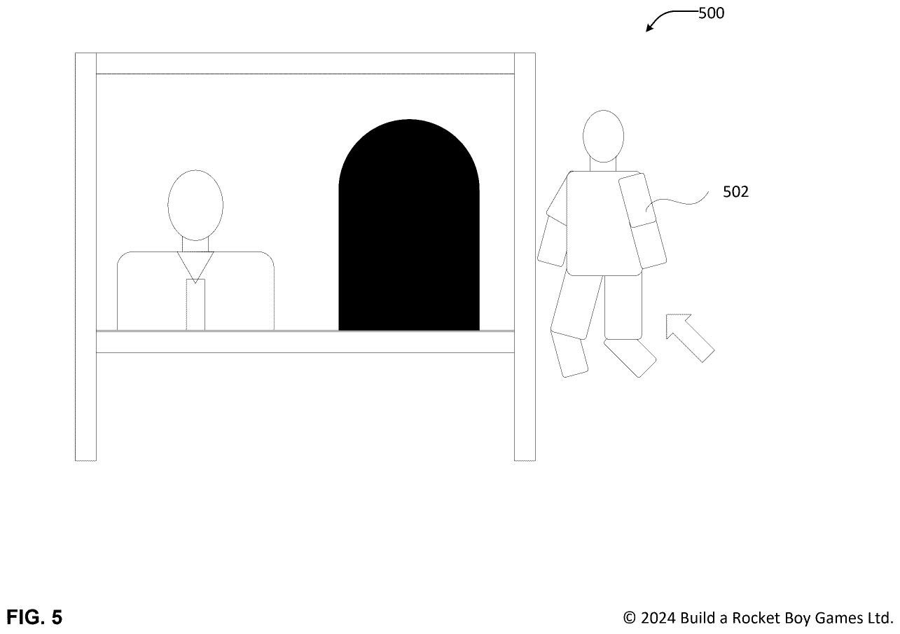

FIG. 5 is an example three-dimensional character jumping into a linear content display. Here, the player three-dimensional character 502 has moved closer to the display within the three-dimensional environment 500, indicating a desire to join the three-dimensional experience associated with the linear content. This action is “jumping into” the linear content?, but the particular interaction may be slightly different. The action triggering the indication of a desire to join the three-dimensional environment associated with the linear content may be merely moving close to the display, walking toward the display, “touching” the display (e.g. by interacting with the display), or walking into or through a nearby portal or doorway associated with the linear content. Preferably, no click or selection or menu operation is necessary for a user to complete the action of transitioning to a new three-dimensional environment associated with the linear content. Instead, the interaction is simplified through the use of the “move into” or “jump into” metaphor.

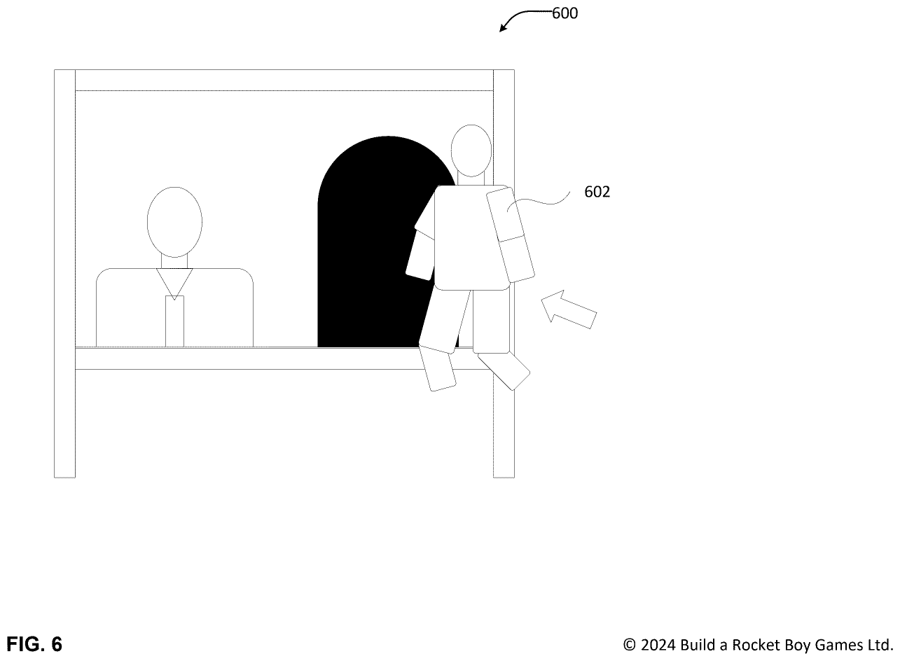

FIG. 6 is an example three-dimensional character jumping into a linear content display. Here, the player three-dimensional character 602 has nearly jumped “into” and continues jumping into the display showing the linear content within the three-dimensional environment 600. The character 602 may continue jumping into the linear content or display showing that content by moving any part of the character into or over the area of the linear content or display of that content.

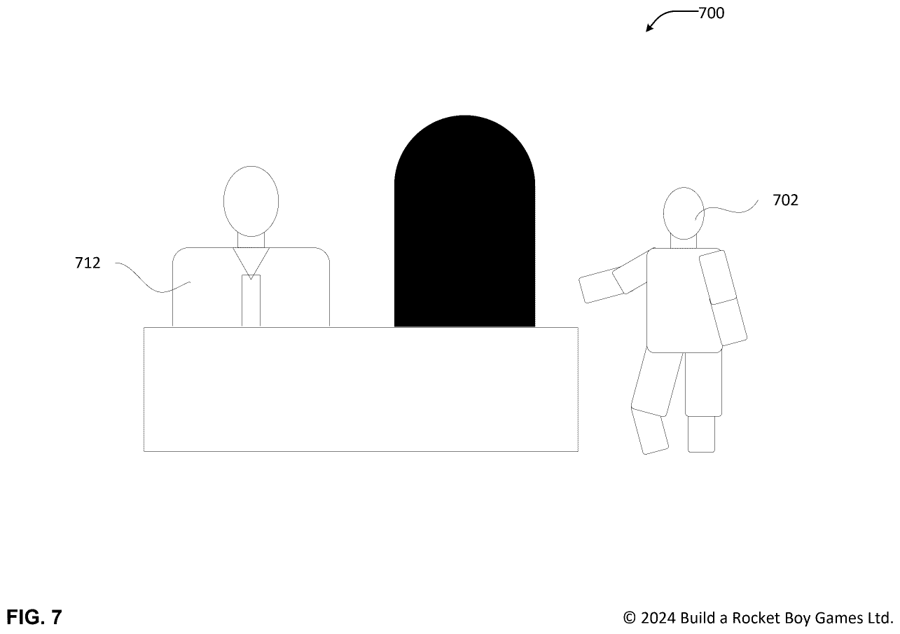

FIG. 7 is an example three-dimensional character transitioned into a new three-dimensional environment previously shown on the linear content display. Here, the player three-dimensional character 702 has moved closely proximate to and/or jumped “through” the linear content and has now joined a new three-dimensional environment 700 where the character 712 is present. Now, the player three-dimensional character 702 may move about in this new, three-dimensional world and engage with the character 712 or perform other actions associated with this three-dimensional experience within the three-dimensional environment 700 associated with the linear content. Character 712 may be the same as character 602 or may be a different player character (e.g. may become or take the place of a character from the linear content, like John Wick in a John Wick film).

### DESCRIPTION OF PROCESSES

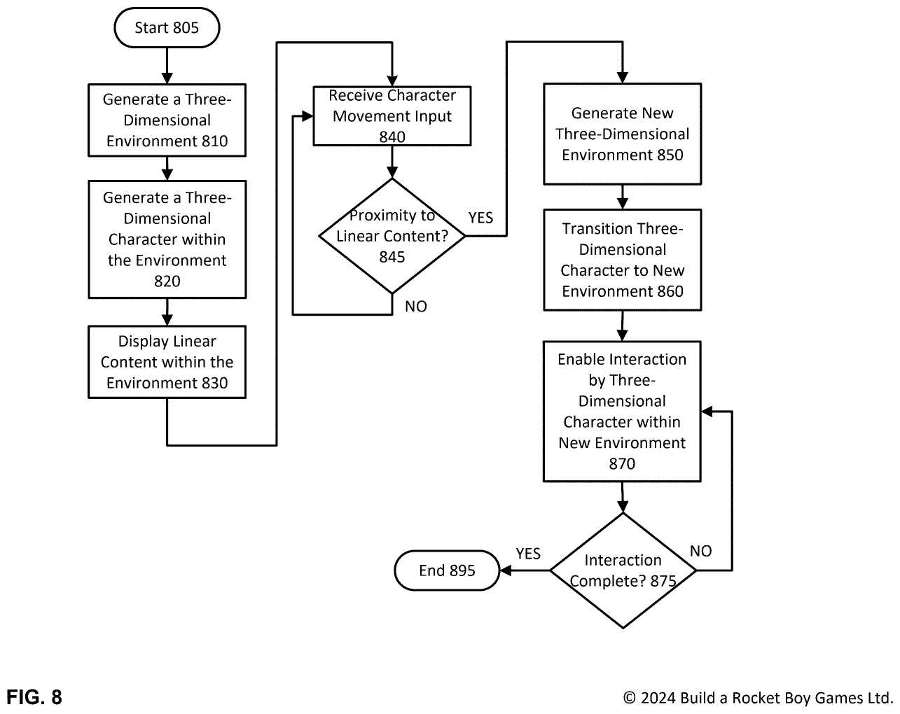

FIG. 8 is a flowchart of a process for linear content transition to a new three-dimensional environment. The flow chart has both a start 805 and an end 895, but the process may be cyclical in nature.

After the start, the process begins with the generation of a three-dimensional environment 810. This is preferably handled by the environment server 320 which generates a three-dimensional world into which players may login and interact with the world and each other. This may be in the form of a traditional multiplayer game to which player characters connect using user computing devices (like user computing device 340). However, it may also be in the relatively new form of a multiverse or metaverse style game experience or world to which a player can connect and interact with others and join many and varied sorts of experiences.

Next a three-dimensional character is generated within the environment at 820. This process involves a player using a user computing device 340 to login to the environment server 320 as confirmed by the authentication functions 325. As a result, the environment server 320 and user computing device 340 together generate a uniform three-dimensional environment in which the player three-dimensional character may move about an interact.

Next, linear content is displayed within the environment at 830. Here, the three-dimensional environment itself plays linear content accessed from the content server 330 that may be viewed by a user using one of the user computing devices 340 to connect to the environment server 320. The display shows up within the three-dimensional environment generated at 810. As discussed above, the display may be user-created or may be present at all times within the three-dimensional environment. The linear content displayed may be set by the operator of the three-dimensional environment or may be selected by a player using a user computing device 340. Regardless, the linear content may be associated—e.g. pre-associated by a maker of the linear content or by the operator of the three-dimensional environment—with a given three-dimensional experience, content or other environment into which the player may interact or engage.

Next, the user computing device 340 receives character movement input 840 which is communicated to the environment server 320 to cause the player three-dimensional character to move about within the three-dimensional environment of the world created by the environment server 320. In this way, as player three-dimensional characters move about within the world, the other individuals participating in that world can see those movements and the entire experience is a bit more social, like a “hang out” or busy taking part in activities within the world, while the linear content may be playing nearby or may be being watched as a group together within the three-dimensional environment.

At 845, a determination is made whether the movement at 840 resulted in close proximity to linear content including an associated three-dimensional environment or experience. If not (“no” at 845), then the process continues to check for character movement at 840 that is in proximity to linear content at 845.

If there is character movement that is in close proximity to linear content (“yes” at 845), then this means that the player three-dimensional character has moved close to content having an associated linear content component. This close proximity may be “jumping into” the associated display, moving near it, clicking on it with a mouse or controller, “touching” the display within a virtual reality rendering of the linear content, walking nearby, or engaging in a particular activity or interaction with a nearby element, button, portal, door, or window. In the preferred case, the player three-dimensional character is merely moved into or through the display (e.g. by jumping or running into it).

Thereafter, the environment server 320 generates a new three-dimensional environment 850. This generation may have actually happened previously, or the experience may always be running or generated from the outset of launch of the environment server 320, but this process is shown here because it some cases, the new three-dimensional environment may not exist until such time as it is needed or used by a player three-dimensional character moving into a display or otherwise indicating a desire to engage in the new three-dimensional experience associated with the linear content.

Further in response to the detection by the environment server 320 of proximity to the linear content at 845, the three-dimensional character is transitioned to the new environment at 860. Here, the environment server 320 removes the three-dimensional character from the three-dimensional environment where the linear content is playing and moves them to (adds them to) the new three-dimensional environment associated with the linear content. This process may take the form of a traditional “character loading” process from a technological perspective. The transition is preferably as seamless as possible for the player three-dimensional character, appearing as though they “walk into” the scene of the linear content. However, in some cases, a load time or transition time may be needed. An animation of teleportation or melding into the linear content or other similar transition may be used to mask any load times.

Thereafter, player three-dimensional character interaction with the new three-dimensional environment is enabled at 870. Once the load-in is complete, the player three-dimensional character may move about, interact with, and otherwise engage with the interactive experience within the new three-dimensional environment. This may be accomplished in much the same way as interactions with the original three-dimensional environment is enabled by the environment server 320 operating in concert with the user computing device 340.

Thereafter, the user may take part in the new three-dimensional environment.

At some point, that experience may be complete. For example, the user may complete the mini-game, complete the ordinary game or complete a session with the ordinary game, or may otherwise indicate that he or she is no longer interested in the new three-dimensional experience. For example, a user may move toward, be in close proximity to or jump into an inverse or unusually-colored version of the linear content that continues to play on a wall (suggesting a Through the Looking Glass-like transition between the two worlds) to thereby trigger the same behavior in reverse moving the player three-dimensional character back to the original “world” of the environment server 320.

Once that occurs (“yes” at 875) indicating that the interaction is complete, then the process ends. Until it is complete (“no” at 875) indicating that the interaction is ongoing, then the interaction continues to be enabled at 870.

The process then ends at 895.

In some cases, only steps 830-860 are performed. In some cases, steps 820 and/or 870 are performed with steps 830-860.

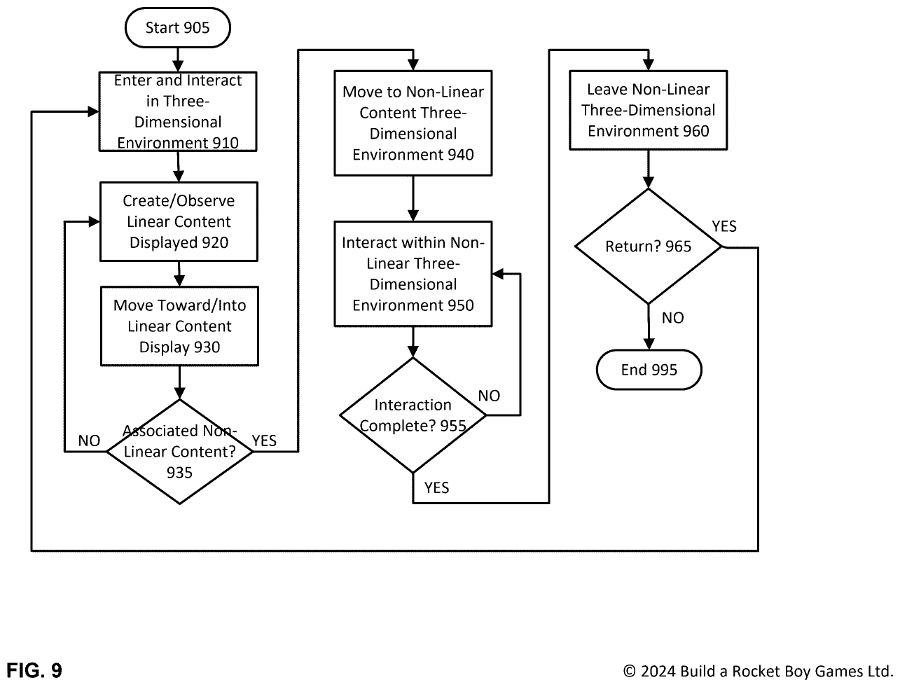

FIG. 9 is a flowchart of a process for linear content transition to a new three-dimensional environment from the perspective of a user. The flow chart has both a start 905 and an end 995, but the process may be cyclical in nature.

First, following the start 905, the user enters and interacts with a three-dimensional environment created by the environment server 320 and the user computing device 340.

The user may then create and/or observe linear content displayed within the three-dimensional environment at 920. As discussed above, this content may be shown and selected by the three-dimensional environment itself or may be user-selected both in location (e.g. a “pop-up” display) and content (e.g. selecting content from a streaming service, a group of available content or a user's own computer).

After that linear content is playing, the user may move their player three-dimensional character toward, in close proximity to, jump into and/or move into the linear content display at 930. Preferably, this is the walk-into or jump-into interaction, but other interactions are possible.

Next, the system determines whether or not there is associated non-linear content (e.g. a three-dimensional experience) at 935. If not (“no” at 935), then the process continues at 920.

If there is (“yes” at 935), then the process continues with movement to non-linear content three-dimensional environment at 940. Here, the new three-dimensional environment is created or joined by the player's three-dimensional character.

The player's three-dimensional character may interact within that new three-dimensional environment at 950 until that interaction is complete (“no” at 955).

Once that interaction is complete (“yes” at 955), the player's three-dimensional character may leave the non-linear three-dimensional environment that was associated with the linear content at 960.

So long as this is not the end of the play session as a whole (“yes” at 955), then the process continues with return to the original three-dimensional environment at 910. This could be the end of the session as a whole. If so (“no” at 965), then the process ends at 995.

The process then ends at 995.

In some cases, only steps 930-940 are performed. In some cases, steps 920 and/or 950 are performed with steps 930-940.

And, if the linear content and the new three-dimensional environment are closely related or designed together to interact with one another, portions of the linear content associated with the new three-dimensional environment may be altered as a result of player actions within the new three-dimensional environment. So, for example, a player may be given a choice within the three-dimensional environment whether to kill a particular character. If the player chooses to do so, the remainder of the linear content from that point forward may no longer have that character present or characters may react to the player action. If the player chooses not to kill that particular character, then the story of the linear content may adapt accordingly with that character still present in the linear content once the interactions with the new three-dimensional environment are complete. In this way, some linear content the three-dimensional content associated with that linear content may together be interactive in a manner similar to a choose your own adventure book.

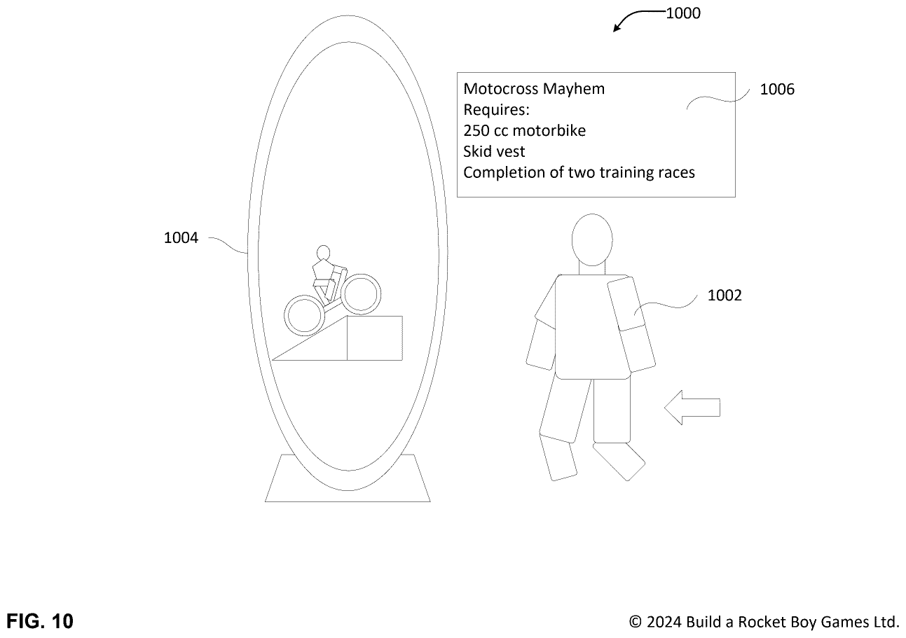

FIG. 10 is an example of a three-dimensional character moving toward a portal 1004 displaying transition information. Here, the three-dimensional environment 1000 includes a portal 1004 and a pop-up display. Though portal 1004 is shown within the three-dimensional environment 1000 as a portal, it may take many forms. As discussed above, and with reference to FIGS. 4-7, the “portal” may in fact be a doorway, a television-like display screen, a window, an archway, or other object within the three-dimensional environment that may be used as a “portal.” And, as used herein, “portal” means a two or three-dimensional object within the three-dimensional environment that is or may be used to transition to a different interactive experience within or in another three-dimensional environment.

The portal 1004 is displaying a motocross game with another player traversing a ramp. This may be real, live footage of another game or another part of a game displayed in the portal 1004. Or, this may be a cartoon, simplified, previously-recorded, or similar version of the game or another part of the game displayed within the portal. Preferably, it is presented as a live stream of an ongoing motocross competition or portion of the game to better entice the player three-dimensional character 1002 to enter the portal 1004 and join the new interactive experience shown thereon. The portal 1004 image may even include information relating to the players (e.g. this motocross rider) in the other game. For example, the avatar being shown to the player three-dimensional character 1002 may be an online “friend” of the player three-dimensional character 1002. This may be automatic, shown by review of the player three-dimensional character 1002's “friends list” within the game or experience and selecting an image for the portal 1004 that corresponds to one or more friends on that list.

As the player three-dimensional character 1002 is viewing the portal 1004 and moves closer to the portal 1004, in this example shown in FIG. 10, a floating pop-up window 1006 may appear on or near the portal 1004. This window 1006 may provide information related to the new interactive experience to which the player three-dimensional character 1002 would be transitioned if the player three-dimensional character 1002 is moved through or elects to move through the portal. The portal in this sense is merely a metaphor for “transition” or a “loading screen,” in a traditional game context, but the portal provides the opportunity to give the player three-dimensional character 1004 more information related to the new interactive experience to which the player three-dimensional character 1002 would be transitioned if they elect to move “through” the portal 1004. The new interactive experience could be an experience related to linear content, as discussed above, and the image shown in the portal could be the associated linear content.

This window 1006 displays a title for the new interactive experience through the portal 1004. Here, that is “Motocross Mayhem.” The window 1006 also indicates that the new interactive experience requires a 250 cc motorbike, a skid vest, and completion of two training races. This is a shorthand—and merely an example shorthand—of information for a player three-dimensional character 1002 to evaluate whether or not they wish to engage in the new interactive experience through the portal.

The first two elements listed, the 250 cc motorbike and the skid vest are examples of “items” within the three-dimensional environment that the player three-dimensional character 1002 must have to engage in the new interactive experience shown. These are merely example items. For other new interactive experiences available through portals, a melee weapon may be required, a shooting weapon may be required, a particular purchase within or outside of the game may be required (e.g. a special key, item, skill (e.g. dancing), downloadable content, etc.), appropriate attire (e.g. an evening gown or tuxedo), or virtually any other in-game item, vehicle, weapon, or skill. The player three-dimensional character 1002 can evaluate, while looking at the portal 1004, whether or not they are in possession of the required items. The skid vest may not literally be required—e.g. a player three-dimensional character 1002 cannot become hurt within the three-dimensional environment, but may represent some level of readiness, or be a key used to access the environment or otherwise signify safety for operation of a motocross game or experience.

The third element listed within the window 1006 is completion of two training races. As is somewhat common in games, players sometimes must complete training exercises before the player is set free to explore the game (or portions of the game) on their own. Here, the player three-dimensional character 1002 is considering joining a motocross game or portion of the game as a new interactive experience. That player three-dimensional character 1002 may be overwhelmed, lost, confused, or potentially have an otherwise poor experience if the player three-dimensional character 1002 joins the Motocross Mayhem new interactive experience without first learning how to operate the required 250 cc motorbike.

Thus, the portal 1004 may fail to operate if the player three-dimensional character 1002 does not have the required items or meet the required prerequisites. Or, the player three-dimensional character 1002 may enter the portal 1004 and be required or prompted to purchase the required items within the three-dimensional environment and may be asked to begin the required two training races before the player three-dimensional character 1002 is allowed to join their friends or otherwise engage with the new interactive experience through the portal 1004.

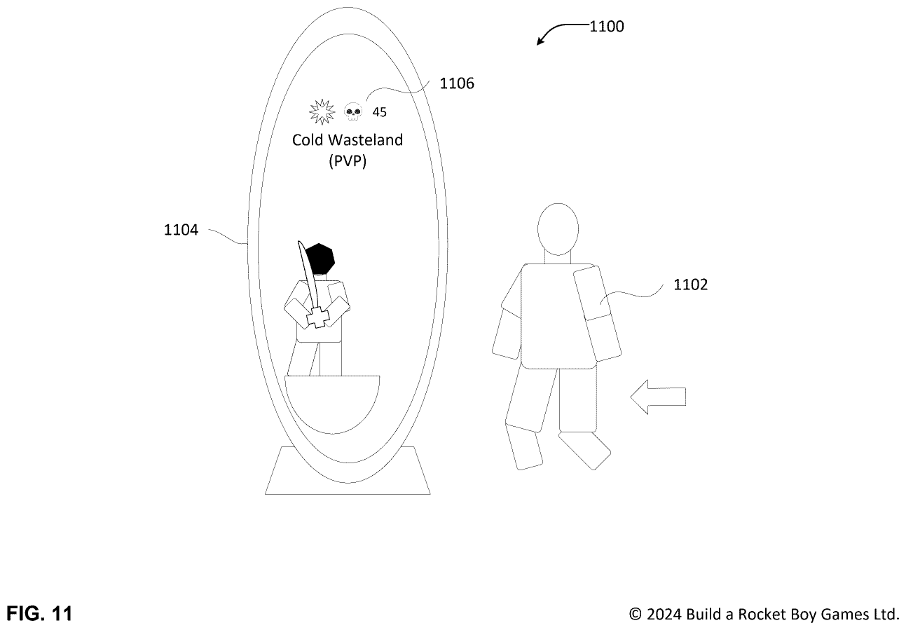

FIG. 11 is an example of a three-dimensional character moving toward a portal 1104 displaying transition information. This is an alternative presentation of the portal 1104 within the three-dimensional environment 1100 as well as the player three-dimensional character 1102 and the associated window 1106. Here, the player three-dimensional character 1102 has moved toward the portal 1104 and the portal depicts an enemy player holding a weapon. A plurality of icons appears within the portal, along with a name for the location/game and an indication that the location is “PVP.” The window 1106 may appear within the portal 1104 itself, for example as an overlay over the live or pre-recorded images of the content through the portal 1104 (which may or may not be present in some cases). So, this example is shown to demonstrate how the information shown as an overlay may look.

The first icon, looking somewhat like a snowflake, can mean that the location is “cold.” Player three-dimensional character 1102 may in some cases require special items (e.g. in-game garments) that offer attributes such as protection from environmental hazards, such as excess heat, excess cold, rain, or snow, and from other dangers, such as poison, magic, lasers, electric shock, etc. These garments or in-game items may render such effects as “cold” or “heat” or “shock” or the like ineffective or of limited effectiveness to the player three-dimensional character 1102. This snowflake icon can represent that the area is “cold” and therefore, the player three-dimensional character 1102 entering this new interactive experience should have suitable cold weather items or garments or gear.

The next icon, appearing as a skull can mean that the area is presumptively or likely to be too-high a level for the player three-dimensional character 1102 or otherwise too difficult for the player three-dimensional character 1102 to have a positive experience. There may be specific settings that must be turned off or prompts that must be traversed before a player three-dimensional character 1102 is allowed to enter a portal bearing a skull icon or otherwise indicating that it is too high a level or too difficult for the player three-dimensional character 1102 to enter or enjoy.

The next icon is simply the number 45, which may be a character level (e.g. within a role-playing game) or an item level (e.g. how powerful average or total items the player three-dimensional character 1102 should have equipped) to enter the new interactive experience). This icon may be duplicative or in addition to the skull icon. In beginner cases especially, sometimes numerical representations are somewhat abstract, where the skull icon is much clearer to a user that there is dangerous through the portal 1104.

A title of the new interactive experience available through the portal 1104 is also shown on the portal 1104. The title is “Cold Wasteland.” This title also suggests the cold aspect of the area shown in the snowflake icon.

Finally, the phrase “PVP” is shown. In this case, this phrase indicates that the zone is player-versus-player, meaning that other player three-dimensional characters within that zone or location or new interactive experience may attack and kill the player three-dimensional character 1102 should the player three-dimensional character 1102 enter through the portal 1104. In some cases, a player three-dimensional character 1102 may be seeking out PVP interactions, so this information may be welcomed. In other cases, the player three-dimensional character 1102 may wish to avoid such interactions and it may make the portal 1104 much less attractive to such a player three-dimensional character 1102. In either case, a warning on the portal 1104 itself can better-inform the player three-dimensional character 1102 of the world beyond the portal 1104.

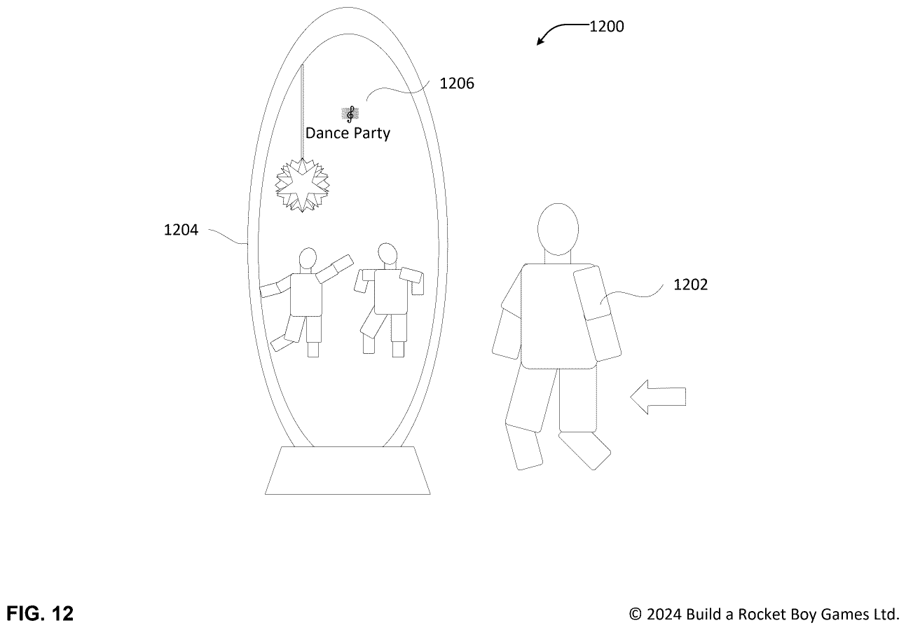

FIG. 12 is an example of a three-dimensional character moving toward a portal 1204 displaying transition information. Here, the player three-dimensional character 1202 is approaching a portal 1204 where a dance party is taking place. The window 1206 is again superimposed within or on the portal 1204, but it may be floating nearby, around, above, below or otherwise present within the three-dimensional environment 1200. The image within the portal shows player three-dimensional characters dancing with a disco ball or other decoration hanging from the ceiling.

The window 1206 superimposed within the portal's image has an icon showing a musical staff. Other, similar icons options might be used, such as musical notes, instruments, images or icons of dancing people or player three-dimensional characters. But, the use of such an icon can be shorthand to the player three-dimensional character 1202 of the new interactive experience through the portal being a non-combat zone and, instead, a place where player three-dimensional characters spend time, dance, talk, chat, interact, and the like.

In addition, the title of “Dance Party” indicates to a player three-dimensional character 1202 viewing the portal 1204 that there is a dance party taking place. Thus, there is no real risk of entering this portal 1204, and the portal 1204 will take the player three-dimensional character 1202 to a new interactive experience where the player three-dimensional character 1202 can dance or chat with other player three-dimensional characters.

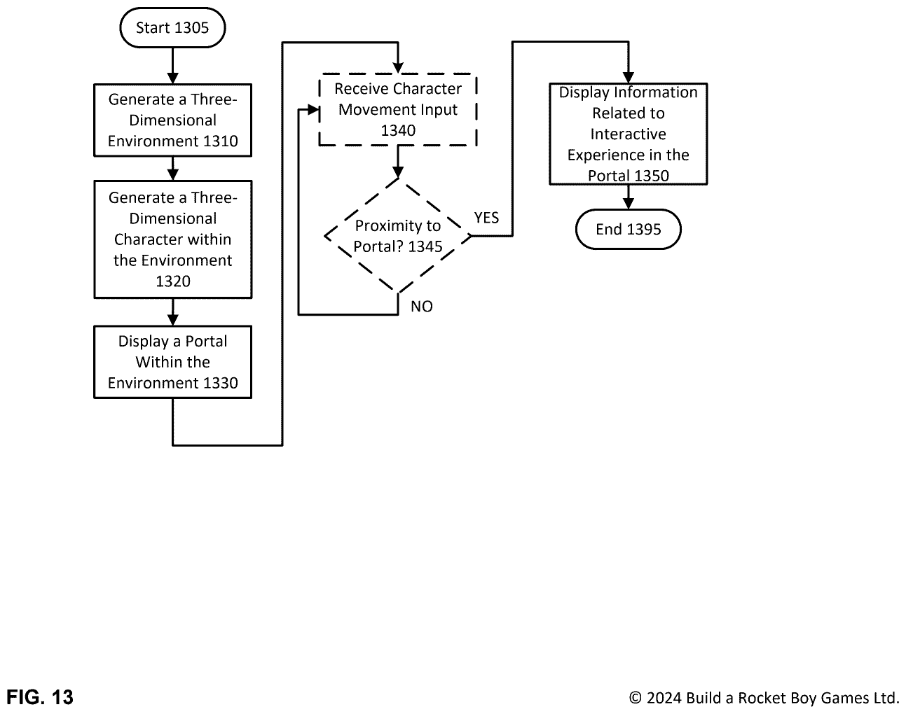

FIG. 13 is a flowchart of a process for displaying transitional information for a new interactive experience in a portal. The process begins with the start 1305 and ends at the end 1395 but may take place many times within a three-dimensional environment.

Following the start 1305, the process continues with generation of a three-dimensional environment at 1310. Here, the three-dimensional environment in which a player three-dimensional character moves and potentially engages with other player three-dimensional characters is created or made visible to the player three-dimensional character. This is preferably a game world or a metaverse-style three-dimensional environment in which players can interact with one another and take part in various games, activities, and experiences.

Then, the three-dimensional player character is generated at 1320. At this step, the player character appears or is able to move and be present within the three-dimensional environment generate at 1310. This may involve the player character moving about in a virtual town square, taking part in a game such as a first person game, an over-the-shoulder third person “character” game, a strategy game, or a racing game, or taking part in a dance party, for example.

Thereafter, a portal is displayed within the three-dimensional computer-generated environment at 1330. The portal may in fact be a door, archway, doorway, window, display screen or other metaphor displayed within the environment. Nonetheless, the portal—whatever form it may take—is shown and made visible to the player three-dimensional character at 1330.

Steps 1340 and 1345 are optional steps, as shown by their presentation in dashed lines. In some implementations, these steps may not be present at all. In such a case, the process will move directly to 1350 (discussed below). Where they are present, the system will receive character movement input at 1340. This may be the player three-dimensional character moving about within the three-dimensional environment. A determination is made whether the player three-dimensional character is in proximity to the (or a) portal at 1345. Here, the question is whether the player three-dimensional character is close enough to trigger the information related to the new interactive experience beyond the portal. If not (“no” at 1345), the process repeats at 1340 and 1345 until such time as the player three-dimensional character is close in proximity to the portal at 1345 (“yes” at 1345).

Following a “yes” at 1345 or if the optional steps are skipped altogether, then the information is displayed on the portal that is related to the interactive experience within the portal at 1350. Here, the new interactive experience information—examples of which are shown in FIGS. 10-12—is shown on or in proximity to the portal within the three-dimensional computer-generated environment.

Thereafter, the process ends at 1395.

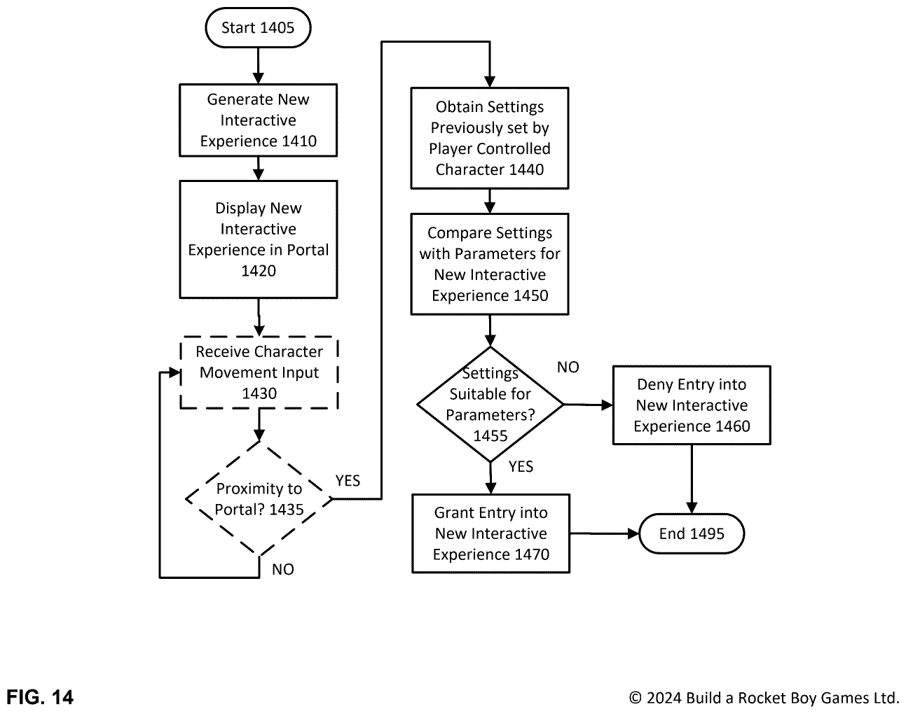

FIG. 14 is a flowchart of a process for comparing previously-set settings with parameters for a new interactive experience as a part of a transition to a new interactive experience through a portal. The process begins with the start 1405 and ends at the end 1495, but may take place many times within a three-dimensional environment. This process assumes that the player three-dimensional character is already present within a three-dimensional computer-generated environment.

Following the start 1405, the process continues with 1410 with generation of a new interactive experience. This may take place many minutes or even days or weeks before the portal disclosed in the next step takes place, but at some point the new interactive experience is initiated at 1410.

Thereafter, the new interactive experience is displayed in a portal at 1420. Here, the new interactive experience is made visible within the portal in the form of a live video feed or stream of the new interactive experience, a trailer of the new interactive experience may be shown on loop or once, an example of the new interactive experience playstyle or world, or a cartoon or simplified version of the new interactive experience may be shown on the portal. Or, simply a title or a portal itself may be shown to indicate that there is a new interactive experience present.

Steps 1430 and 1435 are optional steps, as shown by their presentation in dashed lines. In some implementations, these steps may not be present at all. In such a case, the process will move directly to 1440 (discussed below). Where they are present, the system will receive character movement input at 1430. This may be the player three-dimensional character moving about within the three-dimensional environment. A determination is made whether the player three-dimensional character is in proximity to the (or a) portal at 1435. Here, the question is whether the player three-dimensional character is close enough to trigger the information related to the new interactive experience beyond the portal. If not (“no” at 1435), the process repeats at 1430 and 1435 until such time as the player three-dimensional character is close in proximity to the portal at 1435 (“yes” at 1435).

Following a “yes” at 1435 or if the optional steps are skipped altogether, the settings previously set by the player controlled character are obtained at 1440. Here, the settings related to the types of new interactive experiences in which a player three-dimensional character wishes to engage are obtained. These settings may be that a player three-dimensional character wishes not to engage in player-versus-player content or wishes not to engage in content that is too high a level for the player three-dimensional character or wishes not to engage with content having certain flags (e.g. blood, gore, sexual content, violence, etc.). Though these are described as player settings, they may also be prerequisite settings such as needing a particular item, to have accomplished a task, having certain characteristics or levels or power or skills or abilities. There are many such settings that are possible, and there may be default settings or recommended settings when a game or three-dimensional environment software is installed on a player three-dimensional character's computer.

After those settings are obtained, as the user is near the portal or more generally, those settings are compared with parameters for a new interactive experience through the portal at 1450. Those settings and parameters are compared at 1450. If the settings and parameters comparison excludes the capability or desirability of a given player three-dimensional character entering the portal (“no” at 1455), then entry into the new interactive experience is denied at 1460. If the settings and parameters comparison does not exclude entry through the portal to the new interactive experience, then entry is granted to the new interactive experience at 1470 and the player three-dimensional character may pass through the portal.

The process then ends at 1495.

### Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A system for controlling an interactive virtual environment comprising a computing device for:
generating a three-dimensional computer-generated environment including a player controllable character within the three-dimensional computer-generated environment;
displaying a portal within a portion of the three-dimensional computer-generated environment, the portal active to enable the player controllable character to transition to a new interactive experience; and
displaying information related to the new interactive experience in proximity to the portal and visible to the player controllable character.

2. The system of claim 1 wherein the information is displayed within the portal as the portal is approached by a player controllable character.

3. The system of claim 1 wherein the information is displayed as a popup element near the portal as the portal is approached by a player controllable character.

4. The system of claim 1 wherein the computing device is further for:
obtaining player controllable character settings associated with parameters of interactive environments into which the player controllable character has previously indicated an unwillingness to visit;
detecting the presence of the player controllable character within a threshold associated with transition of the player controllable character into the new interactive experience;
comparing the player controllable character settings with parameters related to the new interactive experience; and
denying entry of the player controllable character into the new interactive experience when the player controllable character settings indicate that the player controllable character is unwilling to visit the new interactive experience with those parameters.

5. The system of claim 1 wherein within the portal is linear content comprising a selected one of a film, movie, television program, television series, trailer for other content, or short.

6. The system of claim 1 wherein the computing device is further for:
generating the new interactive experience into which the player controllable character could transition;
displaying the new interactive experience on the portal within the three-dimensional-computer generated environment, such that the new interactive experience is visible to the player controllable character;
receiving input controlling the player controllable character to move the player controllable character into close proximity to the portal; and
transitioning the player controllable character to a second three-dimensional computer-generated environment embodying the new interactive experience.

7. The system of claim 1 wherein the information is a selected one of the following:
an environmental characteristic of the new interactive experience, the environmental characteristic comprising at least a selected one of: group of: a temperature level of the interactive experience, a hazard type, a number of players or player characters involved in the interactive experience, a danger level of non-player characters within the interactive experience, an estimated or actual time required to complete the interactive experience, or a name, username or other identification for an operator or creator of the interactive experience;
a recommended or minimum level or power of the player controllable character to engage in the new interactive experience;
an interaction type of the new interactive experience, the interaction type comprising at least a selected one of: a player-versus-player area, a player-versus-environment area, an area in which player avatars may congregate to chat or engage in trade, an area for taking part in a musical concert or audiovisual experience, a racing game, a simulation game, a first- or third-person character experience, a strategy game, or a role-playing game; or
a particular characteristic, item, completion, quest, or requirement to access or safely interact with the interactive experience.

8. A method for controlling an interactive virtual environment using a computing device, the method comprising:
generating a three-dimensional computer-generated environment including a player controllable character within the three-dimensional computer-generated environment;
displaying a portal within a portion of the three-dimensional computer-generated environment the portal active to enable the player controllable character to transition to a new interactive experience; and
displaying in proximity to the portal information related to the new interactive experience and visible to the player controllable character.

9. The method of claim 8 wherein the information is displayed within the portal as the portal is approached by a player controllable character.

10. The method of claim 8 wherein the information is displayed as a popup element near the portal as the portal is approached by a player controllable character.

11. The method of claim 8 further comprising:
obtaining player controllable character settings associated with the parameters of interactive environments into which the player controllable character has previously indicated an unwillingness to visit;
detecting the presence of the player controllable character within a threshold associated with transition of the player controllable character into the new interactive experience;
comparing the player controllable character settings with parameters related to the new interactive experience; and
denying entry of the player controllable character into the new interactive experience when the player controllable character settings indicate that the player controllable character is unwilling to visit the new interactive experience with those parameters.

12. The method of claim 8 wherein within the portal is linear content comprising a selected one of a film, movie, television program, television series, trailer for other content, or short.

13. The method of claim 8 wherein the computing device is further for:
generating the new interactive experience into which the player controllable character could transition;
displaying the new interactive experience on the portal within the three-dimensional-computer generated environment, such that the new interactive experience is visible to the player controllable character;
receiving input controlling the player controllable character to move the player controllable character into close proximity with to the portal; and
transitioning the player controllable character to a second three-dimensional computer-generated environment embodying the new interactive experience.

14. The method of claim 8 wherein the information is a selected one of the following:
an environmental characteristic of the new interactive experience, the environmental characteristic comprising at least a selected one of: group of: a temperature level of the interactive experience, a hazard type, a number of players or player characters involved in the interactive experience, a danger level of non-player characters within the interactive experience, an estimated or actual time required to complete the interactive experience, or a name, username or other identification for an operator or creator of the interactive experience;
a recommended or minimum level or power of the player controllable character to engage in the new interactive experience;
an interaction type of the new interactive experience, the interaction type comprising at least a selected one of: a player-versus-player area, a player-versus-environment area, an area in which player avatars may congregate to chat or engage in trade, an area for taking part in a musical concert or audiovisual experience, a racing game, a simulation game, a first- or third-person character experience, a strategy game or a role-playing game; or
a particular characteristic, item, completion, quest, or requirement to access or safely interact with the interactive experience.

15. Apparatus comprising non-volatile machine-readable medium storing a program having instructions which when executed by a processor will cause the processor to:
generate a three-dimensional computer-generated environment including a player controllable character within the three-dimensional computer-generated environment;
display a portal within a portion of the three-dimensional computer-generated environment the portal active to enable the player controllable character to transition to a new interactive experience; and
display in proximity to the portal information related to the new interactive experience and visible to the player controllable character.

16. The apparatus of claim 15 wherein the information is displayed within the portal as the portal is approached by a player controllable character or the information is displayed as a popup element near the portal as the portal is approached by a player controllable character.

17. The apparatus of claim 15 wherein the instructions further cause the processor to:
obtain player controllable character settings associated with the parameters of interactive environments into which the player controllable character has previously indicated an unwillingness to visit;
detect the presence of the player controllable character within a threshold associated with transition of the player controllable character into the new interactive experience;
compare the player controllable character settings with parameters related to the new interactive experience; and
deny entry of the player controllable character into the new interactive experience when the player controllable character settings indicate that the player controllable character is unwilling to visit the new interactive experience with those parameters.

18. The apparatus of claim 15 further comprising a second computing device for:
generate the new interactive experience into which the player controllable character could transition;
display the new interactive experience on the portal within the three-dimensional-computer generated environment, such that the new interactive experience is visible to the player controllable character;
receive input controlling the player controllable character to move the player controllable character into close proximity with to the portal; and
transition the player controllable character to a second three-dimensional computer-generated environment embodying the new interactive experience.

19. The apparatus of claim 15 wherein the information is a selected one of the following:
an environmental characteristic of the new interactive experience, the environmental characteristics comprising at least a selected one of: group of: a temperature level of the interactive experience, a hazard type, a number of players or player characters involved in the interactive experience, a danger level of non-player characters within the interactive experience, an estimated or actual time required to complete the interactive experience, or a name, username or other identification for an operator or creator of the interactive experience;
a recommended or minimum level or power of the player controllable character to engage in the new interactive experience;
an interaction type of the new interactive experience, the interaction type comprising at least a selected one of: a player-versus-player area, a player-versus-environment area, an area in which player avatars may congregate to chat or engage in trade, an area for taking part in a musical concert or audiovisual experience, a racing game, a simulation game, a first- or third-person character experience, a simulation game or a role-playing game; or
a particular characteristic, item, completion, quest, or requirement to access or safely interact with the interactive experience.

20. The apparatus of claim 15 further comprising:
the processor; and
a memory,
wherein the processor and the memory comprise circuits and software for performing the instructions on the storage medium.
